(19) United States
(12) Patent Application Publication
(10) Pub. No.: US 2017/0236447 A1
(43) Pub. Date: Aug. 17, 2017

(54) PRONUNCIATION AID

(71) Applicant: THE BOARD OF REGENTS OF THE UNIVERSITY OF OKLAHOMA, Norman, OK (US)

(72) Inventor: Jonathan Christian Stalling, Norman, OK (US)

(21) Appl. No.: 15/503,271

(22) PCT Filed: Aug. 13, 2015
(86) PCT No.: PCT/US2015/045125

§ 371 Date: Feb. 10, 2017

Related U.S. Application Data
(60) Provisional application No. 62/036,940, filed on Aug. 13, 2014.
(60) Provisional application No. 62/119,604, filed on Feb. 23, 2015.

(51) Int. Cl. G09B 19/06; G09B 5/06

(52) U.S. Cl. CPC G09B 19/06; G09B 5/06

(57) ABSTRACT

The present disclosure provides methods, tools, kits and electronic systems for transcribing non-Chinese language sounds into sound-associated Chinese language characters. The methods, tools, kits and systems use language devices (dictionaries and blocks) based on sound-associated Chinese characters obtained by parsing standard Chinese characters sounds into consonant sounds and vowel sounds which have correspondence to certain standard phonetic graphemes. Sequences of the sound-associated Chinese characters provide existing Chinese phonemes which represent specific sound sequences and syllables in the non-Chinese language.

### REFERENCE TO RELATED APPLICATION

This application claims priority to co-pending U.S. Provisional Application No. 62/036,940, filed on Aug. 13, 2014, entitled “Method and System for Transcription into Chinese” and to co-pending U.S. Provisional Application No. 62/119,604, filed on Feb. 23, 2015, entitled “Pronunciation Aid”, both of which are incorporated herein in their entirety by reference.

### BACKGROUND

When learning how to speak a new language, it is desirable for the learner to be able to correctly pronounce the words of the new language. Correct pronunciation enables and enhances a listener's comprehension of a speaker in that language. Speaking in a comprehensible manner is a particularly valuable ability in the world of business or fields where comprehension of a speaker is crucial, such as air traffic control. One method that has been traditionally used to teach Chinese speakers how to speak non-Chinese languages is to use a syllabary, wherein each sound of the non-Chinese language is represented by a fully pronounced standard Chinese character. These syllabic sounds are then arranged into sequences that approximate the sound of the target language phonemic sequence (word or words) so that the Chinese speaker is given a sequence of full Chinese character sounds which approximates the sound of the particular word or words of the non-Chinese language.

Unfortunately, when Chinese characters are used as a syllabary, each Chinese character represents a full syllable sound, such that the transcription of polysyllabic languages, like English, often results in extreme phonetic distortion due to the extraordinary phonemic sequencing constraints (phonotactics) inherent to the method. For example, English has been transliterated into Chinese characters based on the model of a Sinophonic English Syllabary wherein standard Chinese characters are used to correspond to English language sounds. When standard Chinese characters are used to represent individual English phonemes, many problems inherently arise which defeat the Chinese speaker's goal of an intelligible pronunciation of English words. For example, the English alphabet allows for extreme variations within English syllables (many consonant blends and dusters for instance). Every time an English syllable includes a sequence of sounds not reflected in the pronunciation of a standard Chinese character, echo vowels, deletions, or substitutions, or all of these present themselves. Echo vowels refer to the way each transcribed English consonant is followed by a vowel which often creates a second syllable. For example, the English word “Cat” /k [symbol] t/ becomes /kæ -t [symbol] : / when standard Chinese characters are used. When Chinese speakers try to avoid echo vowels, they tend to substitute or delete sounds which leads to further difficulties in intelligibility. Because these echo vowel permeate all foreign language transcriptions into Chinese Characters, they have also come to permeate spoken forms of non-Chinese languages as spoken by second-language learners in China. While the Sinophonic English Syllabary remains the standard system for transliteration of English and Chinese, it clearly fails to deliver an effective system of transliteration capable of accurately transcribing English (or other non-Chinese language) phonemes into Chinese characters. It is to solving this problem, and others, that the disclosure is directed.

### BRIEF DESCRIPTION OF THE DRAWINGS

Several embodiments of the presently disclosed inventive concepts are hereby illustrated in the appended drawings. It is to be noted however, that the appended drawings only illustrate several typical embodiments and are therefore not intended to be considered limiting of the scope of the presently disclosed inventive concepts.

FIG. 1 depicts one embodiment of a networked based pronunciation aid system of the presently disclosed inventive concepts which includes an electronic device for inputting/outputting via an external network to a remote computer system having a non-transitory memory (database) which is utilized via a processor.

FIG. 2 depicts an exemplary embodiment of a pronunciation aid electronic device of the presently disclosed inventive concepts which includes an input module, a non-transitory memory device/database, a processor, and an output module.

FIG. 3A is an exemplary embodiment of a flow diagram for the pronunciation aid system of FIG. 1 and pronunciation aid device of FIG. 2.

FIG. 3B is another exemplary embodiment of a flow diagram for the pronunciation aid system of FIG. 1 and pronunciation aid device of FIG. 2.

FIG. 3C is another exemplary embodiment of a flow diagram for the pronunciation aid system of FIG. 1 and pronunciation aid device of FIG. 2.

FIG. 4 depicts a screen shot of icons which represent consonant blocks which can be used in at least one embodiment of the pronunciation aid system of the presently disclosed inventive concepts.

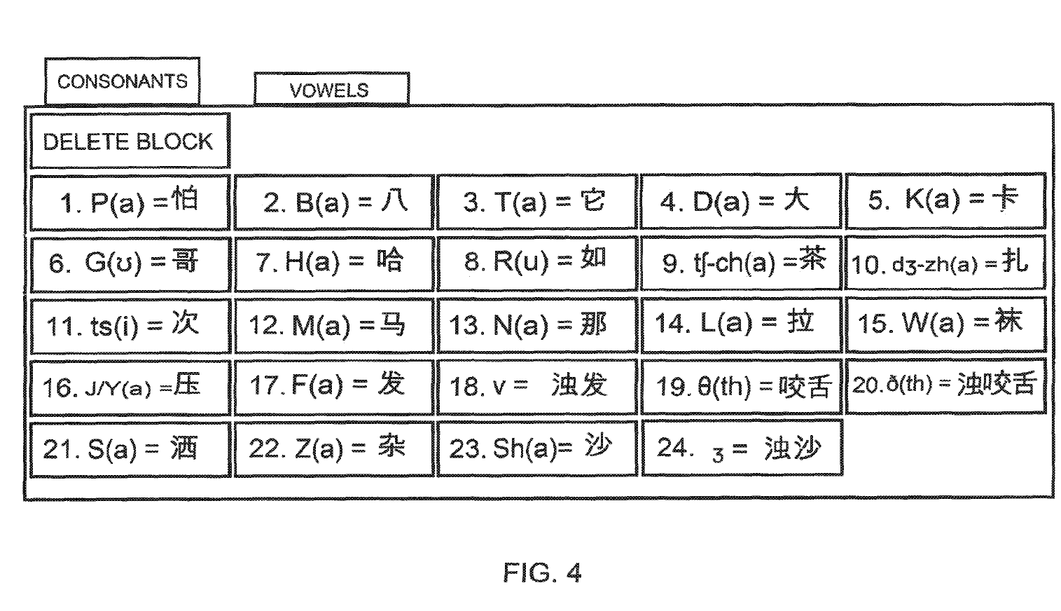

FIG. 5 depicts a screen shot of icons which represent vowel blocks which can be used in at least one embodiment of the pronunciation aid system of the presently disclosed inventive concepts.

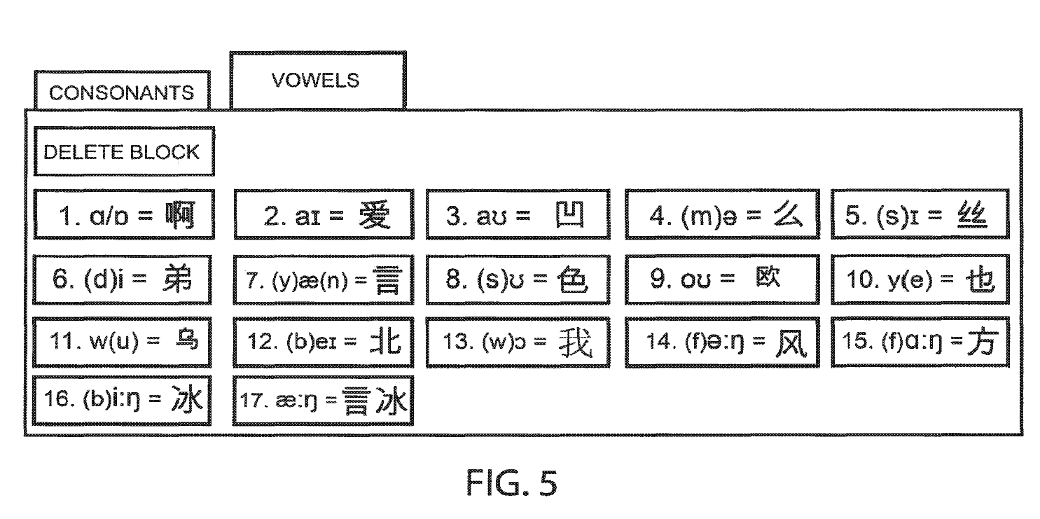

FIG. 6 depicts a screen shot of an exemplary Sinophonic English Alphabet (SEA) dictionary output from the pronunciation aid system illustrating English words beginning with the letters “p h i l” and associated SEA character sequences that are presented to a user in response to the user inputting the letters “p h i l” into the system.

FIG. 7 depicts a screen shot of an exemplary SEA dictionary output from the pronunciation aid system based on a user selecting the word “Philadelphia” in FIG. 16, illustrating the English word “Philadelphia” and the SEA character sequence associated with “Philadelphia”, and illustrating the SEA character sequence separated in a way so as to permit annunciation of the English word.

FIG. 8 depicts a screen shot of a conversational English test function according to the pronunciation aid system of the present disclosure, where English words and corresponding SEA character sequences are presented to a user.

FIG. 9 depicts four sides of an exemplary pronunciation aid tool of the presently disclosed inventive concepts, illustrating a side A having a SEA Chinese character “ [symbol] ”, a side B having an English letter “B” which is assigned to correspond to the SEA Chinese character on side A, a side C having Chinese characters which correspond with consonant ( [symbol] ) and vowel ( [symbol] ) sounds of the SEA Chinese character [symbol] on side A, and a side D having an IPA a consonant sound /b/ and a vowel sound /a/, which correspond to the consonant and vowel sounds [symbol] and [symbol] on side C.

FIG. 10 depicts the four sides of the exemplary pronunciation aid tool of FIG. 4 with the pronunciation aid tool separated into an upper “consonant” portion and lower “vowel” portion used to demonstrate how the two component sounds in the SEA character [symbol] can be isolated, where side A corresponds to side A in FIG. 4A, side B corresponds to side B in FIG. 4B, side C corresponds to side C in FIG. 4C, and side D corresponds to side D in FIG. 4D.

FIG. 11 depicts a perspective view of an exemplary embodiment of a pronunciation aid kit, illustrating three different pronunciation aid tools representing SEA Chinese characters [symbol] , [symbol] , and [symbol] , which correspond to the English letters D, i, and P, respectively.

FIG. 12 depicts the pronunciation aid kit of FIG. 6 showing the faces of each pronunciation aid tool having corresponding English letters D, i, and P.

FIG. 13 depicts a perspective view of the pronunciation aid kit of FIG. 6 with each pronunciation tool partially turned to show a face having the component consonant and vowel sounds which are heard when the character of the first side (FIG. 6) is pronounced.

FIG. 14 depicts the pronunciation aid kit of FIG. 6 showing the faces of each pronunciation aid tool having IPA symbols which correspond to the consonant (upper) and vowel (lower) sounds of the SEA Chinese characters on the faces shown in FIG. 8.

FIG. 15 depicts the pronunciation aid kit of FIG. 6 with each pronunciation aid tool separated and illustrating their component SEA Chinese character consonant (upper) and vowel (lower) sounds.

FIG. 16 depicts the pronunciation aid kit of FIG. 6 with each pronunciation aid tool separated and illustrating their component IPA character consonant (upper) and vowel (lower) sounds.

### DETAILED DESCRIPTION

The present disclosure provides methods, tools, kits, and electronic systems and devices for transcribing non-Chinese language sounds into standard and novel Chinese language characters that are presented to Chinese speakers studying non-Chinese languages. The methods, tools, kits, and electronic systems and devices use language devices, such as dictionaries, blocks, and images based on standard and novel Chinese characters which represent parsed Chinese character sounds (consonant sounds and vowel sounds). The parsed Chinese character sounds correspond to certain standard phonetic graphemes, for example, English graphemes. Sequences of the standard and novel Chinese characters which represent the parsed Chinese character sounds are arranged to represent specific words, syllables, or other sound sequences in the non-Chinese language.

One of the most persistent and difficult hindrances that Chinese speakers have in learning other languages, such as Standard American English, rests in the phonotactic constraints that prevent Chinese speakers from correctly pronouncing many consonant blends and clusters as well as vowel sounds common to other languages. The presently disclosed inventive concepts are directed to methods, tools, kits and electronic systems and devices for transcribing non-Chinese language sounds (for example, English, and more particularly, Standard American English) into recognizable Chinese language characters (e.g., Mandarin characters) to aid Chinese language speakers in learning how to correctly pronounce phonetic sequences and words of the particular non-Chinese language. For example, the presently disclosed Sinophonic English Alphabet (SEA) and SEA based pronunciation aid methods, tools, kits, and electronic systems and devices aid Chinese speakers to learn English language pronunciation. The same principles which underlie the construction of the SEA and SEA based pronunciation aid methods, tools, kits, and electronic systems and devices can be applied for other languages, as discussed in further detail below.

Before describing various embodiments of the presently disclosed inventive concepts in more detail by way of exemplary description, examples, and results, it is to be understood that the presently disclosed inventive concepts are not limited in application to the details of methods and apparatus as set forth in the following description. The presently disclosed inventive concepts are capable of other embodiments or of being practiced or carried out in various ways. As such, the language used herein is intended to be given the broadest possible scope and meaning, and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the presently disclosed inventive concepts may be practiced without these specific details. In other instances, features which are well known to persons of ordinary skill in the art have not been described in detail to avoid unnecessary complication of the description.

Unless otherwise defined herein, technical terms used in connection with the presently disclosed inventive concepts shall have the meanings that are commonly understood by those having ordinary skill in the art. Further, unless otherwise required by context, singular terms shall include pluralities and plural terms shall include the singular.

The electronic systems, pronunciation aid methods, tools, kits, and electronic systems and devices disclosed herein can be made and executed without undue experimentation in light of the present disclosure. While the pronunciation aid methods, tools, kits, and electronic systems and devices of the presently disclosed inventive concepts have been described in terms of particular embodiments, it will be apparent to those of skill in the art that variations may be applied to the pronunciation aid methods, tools, kits, and electronic systems and devices and in the steps or in the sequence of steps of the method described herein without departing from the concept, spirit, and scope of the inventive concepts. All such similar substitutes and modifications apparent to those having ordinary skill in the art are deemed to be within the spirit, scope, and concept of the inventive concepts as defined herein.

As utilized in accordance with the pronunciation aid methods, tools, kits, and electronic systems and devices of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the term “about” is used to indicate that a value includes the inherent variation of error. Further, in this detailed description and the appended claims, each numerical value should be read once as modified by the term “about” (unless already expressly so modified), and then read again as not so modified unless otherwise indicated in context or as explicitly bounded by a specific number. Also, any range listed or described herein is intended to include, implicitly or explicitly, any number within the range, particularly all integers, including the end points, and is to be considered as having been so stated. For example, “a range from 1 to 10” is to be read as indicating each possible number, particularly integers, along the continuum between about 1 and about 10.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

As used herein, the term “non-transitory memory” or “memory” means any type of computer-readable media, with the sole exception being a transitory, propagating signal. Examples of computer readable media include read-writable computer readable media, read-only computer readable media and combinations thereof. Specific examples of types of computer readable media include, but are not limited to, read only memory/bios, removable drives, network/internet storage, physical random access memory, read-write memory, virtual memory, cache memory and central processor unit register(s), flash drive, random access memory, read only memory, static random access memory, dynamic random access memory, programmable read only memory, erasable read only memory, electrically erasable programmable read only memory, primary memory, secondary memory, magnetic based storage devices including but not limited to magnetic tape, floppy disks and hard disks, optical storage media including but not limited to CD ROMs and DVD-ROMs, single in-line memory module, dual in-line memory module, small outline dual in-line memory module, video random access memory, and shadow random access memory.

As noted above, the presently disclosed inventive concepts are directed to methods, tools, kits and electronic systems and devices for aiding Chinese speakers in transcribing non-Chinese language sounds (for example, English, and more particularly, Standard American English phonetic sounds) into recognizable Chinese language characters (e.g., Mandarin characters) to aid the Chinese language speakers in learning how to correctly pronounce phonetic sequences and words of the particular language being learned. Other languages that the presently disclosed inventive concepts can be applied to, for conversion to Chinese characters include, but are not limited to, French, German, Spanish, Italian, Portuguese, Dutch, Norwegian, Swedish, Czech, Finnish, Greek, Hungarian, Hebrew, Hindi, Bengali, Persian, Urdu, Arabic, Polish, Javanese, Turkish, Japanese, Korean, Thai, Malay, Vietnamese, Russian and other Chinese dialects. The novel pronunciation aid methods, tools, kits, and electronic systems and devices described herein aid in the phonetic transcription of most languages into Chinese characters without resorting to non-Chinese alphabets (Roman, Cyrillic, Hangul, or syllabaries as used in Japanese).

In certain embodiments for teaching English pronunciation, the methods, tools and kits use a substrate in having functional printed matter that utilizes a Chinese character alphabet, which in at least one non-limiting embodiment is also referred to herein as the Sinophonic English Alphabet (SEA), corresponding or assigned to English letters, corresponding SEA character consonants and vowels, and corresponding IPA consonants and vowels. The SEA, while primarily relying on standard Chinese characters to represent certain English language sounds, may include one or more contrived Chinese-type characters that provide phonetic sounds used in the English language but which do not exist in the Chinese language. In other embodiments, as described in further detail below, the methods, tools, kits, and electronic systems and devices may be implemented via a computer system, desktop computer, laptop computer, computer notebook or pad, smartphone, tablet, smartwatch, computerized vision device, or other device comprising a processor. The substrate can be a material manufactured in thin sheets from, for example, the pulp of wood or other fibrous substances, resins, or the like, that is used for receipt and display of the functional printed matter. The functional printed matter can be applied to the substrate by writing, embossing, drawing, or printing, for example. The substrate can also be a device in which the printed matter is represented in a computer-readable format which cannot be perceived by a human without the assistance of an electronic input/output device. For example, the substrate can be a non-transitory memory. As discussed herein, pronunciation aid tool may be in the form of a block, a flat plate or tile, or an image of a block, plate, or tile and the pronunciation aid kit may be in the form of a plurality of blocks, plates, tiles, or images thereof. The blocks, plates, or tiles may be made of any material usable in the construction of a block including, but not limited to, cellulose of any form including wood and paper, plastic, including moldable thermoplastic polymers, metals, and ceramics. The term “block” is intended to refer not only to standard blocks such as cubes or rectangular blocks with 6 sides but also to other block structures that may have more or less than six sides (e.g., pyramids) and may also to any structure which has at least two visible faces or surfaces, whether non-digital or digital. The pronunciation aid can also be constructed in the form of, for example, a crossword puzzle, a Scrabble game, a board game, or other type of table game (e.g., “dominos”) or word game.

### Sinophonic English Alphabet (SEA)

The SEA utilized herein is a novel language device based on a set of phonetic symbols and standard and contrived Chinese characters which represent sounds obtained by parsing standard Chinese characters into initial consonant sounds (i.e., onsets) and vowel sounds (i.e., codas). An example of a SEA that can be used with the electronic systems and devices, pronunciation aid tool and kits and the methodologies of the presently disclosed inventive concepts includes, but is not limited to, the Chinese characters representing consonants listed in Table 1 below, and the Chinese characters representing vowels listed in Table 2 below.

The consonant-associated Chinese characters representing consonant sounds may include:

TABLE 1

| | | | |
|---|---|---|---|
| p = [symbol] | b = [symbol] | t = [symbol] | d = [symbol] |
| k = [symbol] | g = [symbol] | f = [symbol] | v = ( [symbol] ) |
| θ(th) = [symbol] | δ(th) = [symbol] | s = [symbol] | z = [symbol] |
| ∫(sh) = [symbol] | 3 = [symbol] | h = [symbol] | r = [symbol] |
| t∫ (ch) = [symbol] | m = [symbol] | n = [symbol] | ts = [symbol] |
| j(y) = [symbol] | kw = [symbol] | L = [symbol] | w = [symbol] |

The vowel-associated Chinese characters representing vowel sounds may include:

TABLE 2

| | |
|---|---|
| [symbol] = [symbol] | [symbol] : = [symbol] |
| [symbol] / [symbol] = [symbol] | [symbol] : = [symbol] |
| [symbol] = [symbol] | [symbol] : = [symbol] |
| æ = [symbol] | æ: = [symbol] |
| [symbol] = [symbol] | [symbol] : = [symbol] |
| o [symbol] = [symbol] | o [symbol] : = [symbol] |
| e = [symbol] | e: = [symbol] |
| ju = [symbol] | ju: = [symbol] |
| a [symbol] = [symbol] | a [symbol] : = [symbol] |
| a [symbol] = [symbol] | a [symbol] : = [symbol] |
| e [symbol] = [symbol] | e [symbol] : = [symbol] |
| [symbol] [symbol] = [symbol] — | [symbol] [symbol] : = [symbol] — |
| [symbol] : [symbol] = [symbol] | [symbol] : [symbol] = [symbol] |
| æ: [symbol] = [symbol] | i: [symbol] = [symbol] |
| i = [symbol] | i: = [symbol] |
| [symbol] = [symbol] | [symbol] : = [symbol] |

The term “SEA” where used herein can refer not just to the set of Chinese characters and non-Chinese phonetic symbols shown in Tables 1 and 2 but to any alphabet comprising Chinese characters associated with non-Chinese language phonetic symbols, phonemes or sounds, wherein the Chinese characters are associated with specific parsed Chinese character consonant or vowel sounds. Therefore, for the purpose of the present disclosure, Chinese characters representing consonants may be referred to herein as “consonant-associated Chinese characters” that represent parsed Chinese character consonant sounds, and Chinese characters representing vowels may be referred to herein as “vowel-associated Chinese characters” that represent parsed Chinese character vowel sounds. Collectively, these consonant-associated and vowel-associated Chinese characters may be referred to herein as “sound-associated Chinese characters.” Further, sequences of sound-associated Chinese characters may be referred to herein as “sound-associated Chinese character sequences.”

Generally, the SEA is a set of standard Chinese characters (e.g., Mandarin characters) that represent parsed Chinese character consonants and vowels, enabling the elimination of component sounds that tend to negatively impact the standard pronunciation of a word in a non-Chinese language. More specifically, parsing standard Chinese characters into consonant-associated Chinese characters and vowel-associated Chinese characters involves analyzing one or more individual component phonetic sounds of a standard Chinese character and eliminating at least one component phonetic sound (a consonant or vowel) to obtain a phonetic sound intended to be associated with a particular non-Chinese character, e.g., an English letter or syllable. The terms “cut” or “cutting” can be used in place of the terms “parse” or “parsing” to indicate the “removal” of at least one part of the component phonetic sound of the standard Chinese character. Two or more (e.g., 2, 3, 4, 5, 6, 7, 8, or more) of these component phonetic sounds of the SEA Chinese characters, e.g., the parsed sounds, can then be combined into a SEA Chinese character sequence providing existing Chinese phonemes arranged in newly sequenced ways to represent specific non-Chinese (e.g., English) sound sequences and syllables. The SEA more accurately transcribes English into Chinese characters (transliteration) than conventional methods, and also restructures the contact zone between the two languages allowing Chinese speakers, e.g., Mandarin speakers, to learn how to avoid inherent problems associated with Sinophonic pronunciations (e.g., the problem of echo vowels and common substitutes and deletions).

The SEA (or equivalent alphabet based on similar Chinese characters) converts non-Chinese phonemes (sounds), for example. English phonemes, into a phonetic alphabet composed of selected standard and contrived (new) Chinese character components by re-sequencing onsets (initial consonants) and codas (vowels and or vowels+final consonants) into sequences of, for example, English phonemes. Also, due to the fact that English contains several phonemes that may not be available in other languages, here Mandarin Chinese, in certain embodiments of the presently disclosed inventive concepts, the SEA includes several contrived (new) Chinese characters, which semantically suggest the placement of vocal organs required for the production of the sounds.

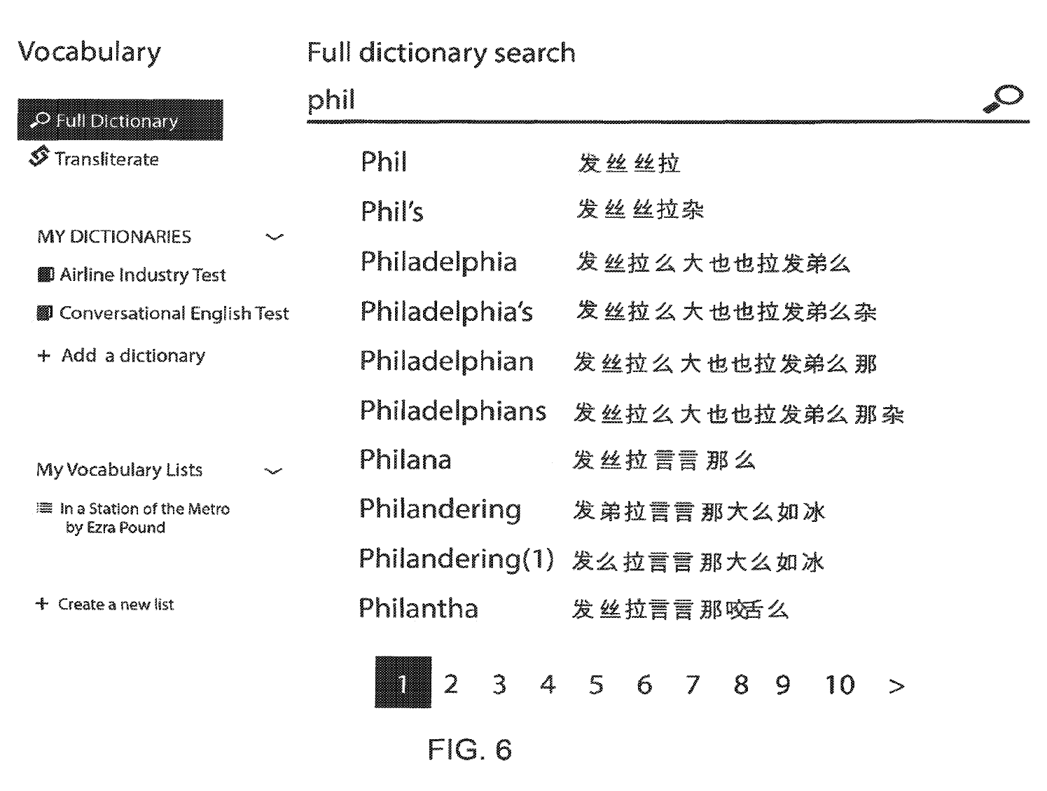

Using the sound-associated Chinese characters associated with the parsed Chinese character sounds, the present disclosure also contemplates the creation of a Chinese-English dictionary, a portion of which is shown in FIG. 6. The Chinese-English dictionary is comprised of English words and their corresponding sound-associated Chinese character sequences formed using sound associated Chinese characters specifically associated with parsed Chinese character sounds.

The system of the presently disclosed inventive concepts, e.g., as embodied by the SEA, solve numerous phonotactic shortcomings of conventional methods for transcribing one language to another, in this exemplary embodiment English to Chinese, so that English sounds can be pronounced more effectively by Chinese speakers and allows for other possible uses derived from the ability to write non-Chinese languages in Chinese character only environments. The SEA, for example, allows users to accurately transliterate English (e.g., Standard American English) into Chinese characters (based on a standard Mandarin pronunciation). The SEA provides a correspondence between English speech sounds transcribed in phonetic scripts like (IPA: International Phonetic Alphabet or similar Latin based phonetic alphabet) characters and standard and contrived Chinese Characters which correspond to English phonetic sequences (in the SEA). Using the present method, English phonemes can be transcribed into Chinese characters. The sound-associated Chinese characters of the SEA generally have standard Mandarin pronunciations (with both consonant and vowel sounds) but when used in accordance with the methods disclosed herein, are intended to be pronounced using only one or the other of the inherent consonant sound (i.e., onset) or vowel sound (i.e., coda), but not the entire standard sound associated with that Chinese character. These parsed Chinese character sounds are then arranged according to English phonetic patterns thereby forming new sound-associated Chinese character sequences which correspond to particular English words or syllable sequences. It is noted that in the pronunciation aids systems and devices described herein, the sound-associated Chinese characters representing parsed consonants and vowels can be differentiated through font, color, underlining or any other visual stimuli or means to distinguish between characters indicating vowels rather than consonants or consonants rather than vowels.

By utilizing sound-associated Chinese characters specifically designated to represent one or the other parsed sound value, the sound-associated Chinese characters used in the SEA correspond more closely to Standard American English phonetics than do the conventional transliteration system, which relies on sounds of completely pronounced, unparsed Chinese characters. The ease of learning and using the presently disclosed system arises from the fact that the sound-associated Chinese characters (or other appropriate Chinese characters) have phonetic sound values already familiar to speakers of standard Chinese speakers, e.g., Mandarin speakers.

### EXAMPLES

The methods, systems, kits, and aids of the present disclosure, having now been generally described, will be more readily understood by reference to the following examples. The following examples of use and construction of the SEA are to be construed, as noted above, only as illustrative, and not as limitations of the disclosure in any way whatsoever. Those skilled in the art will promptly recognize appropriate variations from the various procedures, methods, and components described herein.

In an example of transcription using the previously known, conventional Sinophonic English Syllabary transliteration system, the English words “speak” and “excuse” (verb) are transcribed as “ [symbol] /si-pi-ke/ and “- [symbol] ” / yi/ke/si/ke/you/si/ respectively. In these examples, echo vowels are inserted after each of the English consonants. For example, in the first example after the English consonants /s/ and /k/, and in the second example after the English consonants /k/, /s/, the second /k/ and the final /s/, there are forced vowel substitutions: the long /e/ sound for the short /e/ initial value in both words, and another following the final consonants /k/ and /s/. It is noted that individual sounds or phonemes are often notated by “slashes” (/ /) while graphemes may be notated by “angle brackets” (< >)). These extraneous syllables interfere with the standard pronunciation of the English word and throw off the Chinese speaker's rhythm and cadence at a segmental and super-segmental scale rendering the spoken Sinophonic English often unintelligible. Alternatively, when transcribing “speak” and “excuse” (verb) using the SEA of the presently disclosed inventive concepts, “speak” becomes “ [symbol] ” /s-b-i-k/ and “excuse” becomes [symbol] / i-k-s/k-y-uu-z/. In the SEA transcription each English phoneme is derived from a single parsed Chinese character sound corresponding either to a consonant or vowel sounds and sequenced as the English word. As a result, all sounds have become disambiguated and no echo vowels, deletions, or substitutions remain. As noted above, characters representing consonants and vowels can be differentiated through underlining, color or other visual cues or stimuli. For example, all consonant-associated Chinese characters could be “blue” while all vowel-associated Chinese characters could be “red.” A user would thus understand that only the consonant component of a “blue character” should be pronounced, while only the vowel component of a “red character” would be pronounced.

As another example, longer, more complex words (e.g., polysyllabic words with consonant clusters) present even greater difficulties for conventional Sinophonic English Syllabary spellings but can be readily improved with spellings using the methods and systems disclosed herein. For example, the word “describe” (in IPA: diskraib), is a word with three consecutive consonants. Using the conventional Sinophonic English Syllabary, “describe” would be conventionally transliterated as “ [symbol] /di-si-ka-lai ba/, where the first syllable “di” is substituted because of the phonotactic constraint that prevents /d/ to /e/ paired with the short /i/ sound. And, since every consonant carries an extra vowel sound (echo vowel) “s” becomes “si”, “Kr” becomes “Ke” (“Ka” or “Kai”), and the “R” would likely be substituted with /l/ so that the speaker could link the “R” to the vowel sonorant “ai” as standard Chinese characters do not allow for an /r+ai/ sequence. The sequence would then finish with another echo vowel “b+a or b+u” (or alternatively the who ending consonant could be deleted). However, using the sound-associated Chinese characters (e.g., the SEA), each sound in the English (or non-Chinese) language is associated with a corresponding Chinese character, which as noted above draws its phonetic value from its Chinese pronunciation parsed into consonant and vowel sounds. Thus, the resulting SEA Chinese character sequence for the English word “describe” is “ [symbol] ” which enables a short /i/ sound in the first syllable, and does not include echo vowels, for example between /k/ and /r/. Each consonant and vowel sound has a clear correspondence to the sounds of the English word so that the Chinese speaker can properly pronounce the word “describe”.

As another example, using the SEA, differences between minimal pairs dealing with consonants can be adjusted allophonically (i.e., with shifts in vowel lengths) rather than simply in using different consonant graphemes. By doing this, Chinese speakers, e.g., Mandarin speakers, would recognize the durational differences in vowels and they would be introduced to the nature of vowel+consonant relationships which are common to English speakers but uncommon to Chinese speakers.

Using the SEA, minimal vowel pairs (e.g., as exemplified in Table 3 below) which tend to be difficult for Chinese speakers, e.g., Mandarin speakers, become easier for such speakers to pronounce. This is so because the SEA Chinese characters are dissociated from the fossilized substitutions in Sinophonic English pronunciations. In the pair “beat/bit” in Table 3 below for example, a Mandarin Chinese speaker would not be able to substitute the short “I” with the long “i:” since the Mandarin Chinese speaker would be reading characters with these vowel sounds in the vowel position within the words.

TABLE 3

| Minimal Consonant Pairs | | |
|---|---|---|
| English Word/ | English Word/ | Targeted |
| SEA Sequence | SEA Sequence | Contrasts |
| pick/ [symbol] | pig/ [symbol] | /g/-/k/ |
| cap/ [symbol] | cab/ [symbol] | /p/-/b/ |
| bed/ [symbol] | heat/ [symbol] | /d/-/t/ |
| beat/ [symbol] | bit/ [symbol] | /i/-/ [symbol] / |
| set/ [symbol] | sat/ [symbol] | /ε/-/æ/ |

Using the methods and systems disclosed herein, the vowel sounds create cognate differentials for minimal pair practice in ways that bring greater phonemic awareness to Chinese speakers and produce intelligible oral differentiation. In more technical terms, the vowels can be seen in overlapping distribution, and become clearly “contrastive” that is not only are the characters reminders of phonetic values that cannot be deleted (as easily), they also clearly create sounds with lexical contrastive values. For example, the word “book” can take different vowel (sonorant) variations and remain unconfused with other words while other contexts have a very limited range before interfering with contrastive meanings. In any case, the sound values ascribed to English using the presently disclosed methods and systems are vastly more accurate than conventional transcriptions methods.

Further, using the presently disclosed methods and systems, word stress (often marked by an accent marks in Romanized phonetic scripts) is marked by doubling the SEA vowel characters in the stressed syllables. By doing this, Mandarin speakers are forced to cognize the durational differences in vowels within stressed and unstressed syllables, and they are introduced to the nature of stress as a form of vowel duration rather than an arbitrary didactical mark. For example: the word “Trapezoid” (‘tr [symbol] d) would be transcribed into the SEA Chinese character sequence [symbol] [symbol] . In this transcription, the first syllable's vowel /æ/ is transcribed by [symbol] but this SEA Chinese character is doubled ( [symbol] ) so that the first syllable's vowel is elongated to carry the stress of the vowel.

As explained above, the sound-associated Chinese characters of the presently disclosed inventive concepts can be adapted to other languages. For example, “hello” greetings used in several languages are shown below in Table 4. Table 4 also includes the International Phonetic Alphabet (IPA) sequence for the word “hello” in the identified language, and a corresponding SEA Chinese character sequence transcription.

TABLE 4

| Language | Original Alphabets | IPA | SEA Chinese Character Sequence |
|---|---|---|---|
| English | Hello | he 'lo [symbol] | [symbol] |
| French | bonjour | bõ ' [symbol] ur | [symbol] / [symbol] |
| German | Guten Tag | 'gut [symbol] n tag | [symbol] / [symbol] / [symbol] |
| Spanish | Hola | ' [symbol] o la | [symbol] / [symbol] |
| Italian | Ciao | 't∫a: o | [symbol] / [symbol] |
| Japanese | [symbol] | kon ni t∫i wa | [symbol] / [symbol] / [symbol] / [symbol] |
| Russian | [symbol] ! | 'zdrov stvuj t^{j}e | [symbol] / [symbol] |

Using the SEA one skilled in the art would readily recognize that a dictionary of non-Chinese language words with corresponding sound-associated Chinese character sequences based on the SEA can be created. As noted above, FIG. 6 illustrates one exemplary page of such a dictionary.

### Electronic Devices and Systems

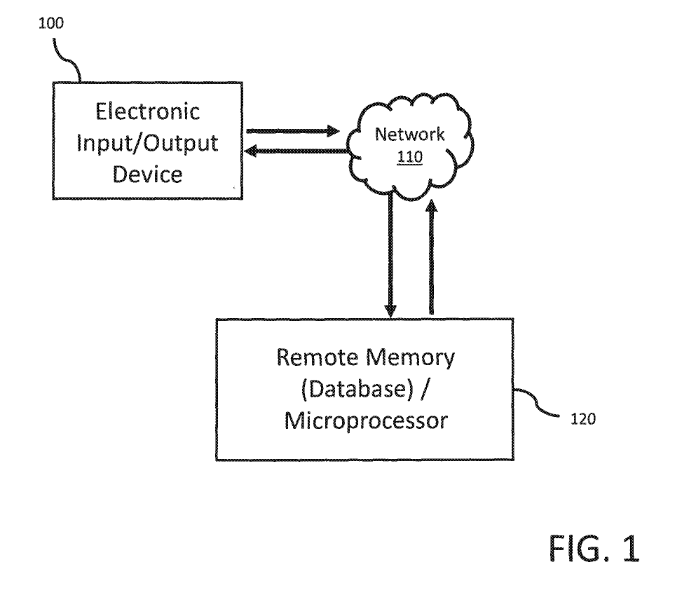

Referring to FIGS. 1-3, certain embodiments of the presently disclosed inventive concepts are directed to machine-driven pronunciation aid systems and methods implemented via computer or other processor-driven devices for automatically transcribing syllables of non-Chinese language, e.g., English, into sound-associated Chinese characters via association with phonetic alphabetic spellings, e.g., IPA spellings, as explained herein.

In one exemplary embodiment, the electronic systems, devices or other processor-driven devices can automatically transcribe one or more non-Chinese language syllable sequences (e.g., an English word) into sound-associated Chinese character sequences via association with phonetic alphabetic (e,g., IPA) spellings as explained herein. In another embodiment, the electronic systems, devices or other processor-driven devices can access a Chinese-English dictionary comprising English language words and syllable sequences and corresponding sound-associated Chinese character sequences (such as described above), which are stored in memory. In one embodiment, depicted herein in FIG. 1, the methods of the presently disclosed inventive concepts are implemented via an electronic device 100 which comprises an input module and an output module (or an input/output module) a memory device and a processor.

The term “processor” as used herein means a single processor or multiple processors working together to execute processor executable instructions. Exemplary embodiments of the processor may include a digital signal processor (DSP), a central processing unit (CPU), a field programmable gate array (FPGA), a microprocessor, a Multicore processor, a quantum processor, application-specific integrated circuit (ASIC), a graphics processing unit (GPU), a visual processing unit (VPU) and combinations thereof. In certain embodiments the memory device is non-transitory. The memory device can use any suitable topology such as being local and/or remote to the processor and/or distributed. The processor is operably coupled with the memory via a path which can be implemented as a data bus, a wired network, an optical network, a wireless network and combinations thereof allowing bi-directional communication between the processor and the memory device, for example. The processor may be configured to communicate with the input module and with the output module via paths, which may be one or more data busses and/or networks, for example. It is to be understood that in certain embodiments using more than one processor, multiple processors may be located remotely from one another, located in the same location, or comprising a unitary multi-core processor (not shown). The processor may be configured to read and/or execute processor executable code stored in the one or more memories and/or of creating, manipulating, altering, and storing computer data structures into the one or more memories.

Suitable electronic devices 100 include, but are not limited to, desktop computers, personal computers, laptop computers, computer workstations, servers, mainframe computers, handheld computer devices, personal digital assistants, pagers, camera phones and smartphones (e.g., iPhone), cellular/mobile telephones, fax machines, smart appliances, gaming consoles, digital cameras, digital vision devices (e.g., Google Glass), digital music players (e.g., iPod), tablet/notebook computers (e.g., iPad), video players, e-readers (e.g., Kindle), DVD players, Blu-ray players, televisions, copy machines, scanners, car stereos, DVRs, augmented reality devices (Hololens, Google Glass), virtual reality devices (e.g. Oculus Rift) and home entertainment centers. The electronic device 100 is connected wirelessly or via wire, cable, or optic fiber to a network 110 which may include the Internet, an intranet, a LAN/WAN/MAN, Ethernet, satellite, combination of networks or any other suitable implementation of communication. The network 110 is, in turn, in communication with a remote computer system including one or more memory(database)/processor device 120 which stores the Chinese/Non-Chinese language dictionary and program instructions as described herein, and means for (the processor) implementing the program instructions. The Chinese/Non-Chinese dictionary is stored as a database in a memory portion of the remote memory (database)/processor device 120.

In one embodiment, a user inputs a non-Chinese language syllable sequence (e.g., an English word) into the electronic device 100. The input, in certain non-limiting embodiments, may occur by typing on a keyboard or touch screen, by “touch capture” or “spot input” of text on a screen, or by audio-to-text conversion of voice input. The keyboard may have a plurality of keys, each representing a different phonetic character, e.g., an IPA character. The non-Chinese language syllable sequence (either before or after conversion to a phonetic alphabet spelling, or as the original non-Chinese language syllable sequence) is communicated via the network 110 to the remote memory(database)/processor device 120 where the non-Chinese language syllable sequence is transcribed into a sound-associated Chinese character sequence, as explained above. In another embodiment, when the non-Chinese language syllable sequence has been input, a corresponding sound-associated Chinese character sequence is selected from the Chinese/Non-Chinese dictionary and the sound-associated Chinese character sequence is then communicated back to the electronic device 100, via the network 110, where it is stored and/or expressed or displayed as a text and/or audio output for use by the user in accordance with the present disclosure (e.g., see FIGS. 6-8, explained in further detail below).

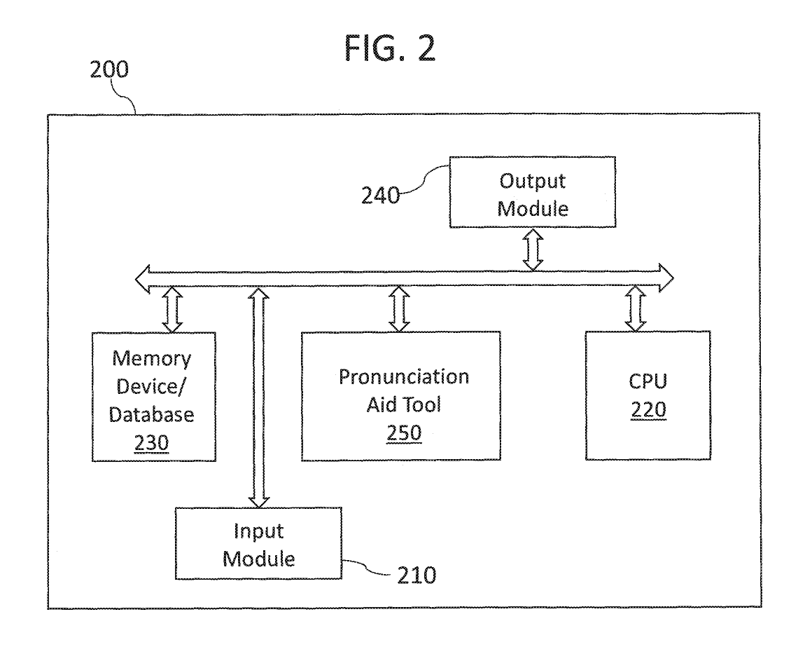

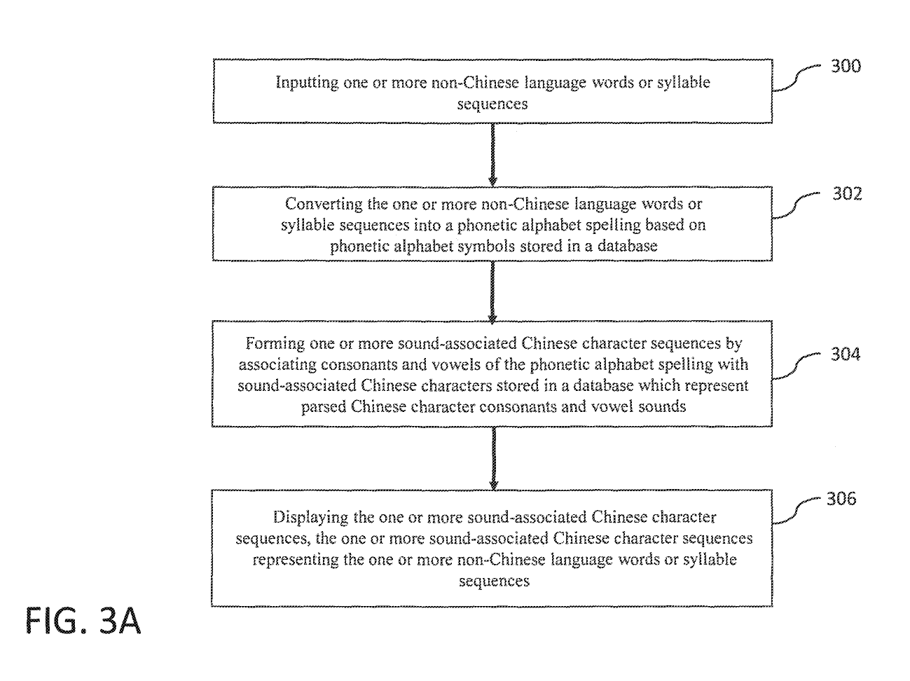

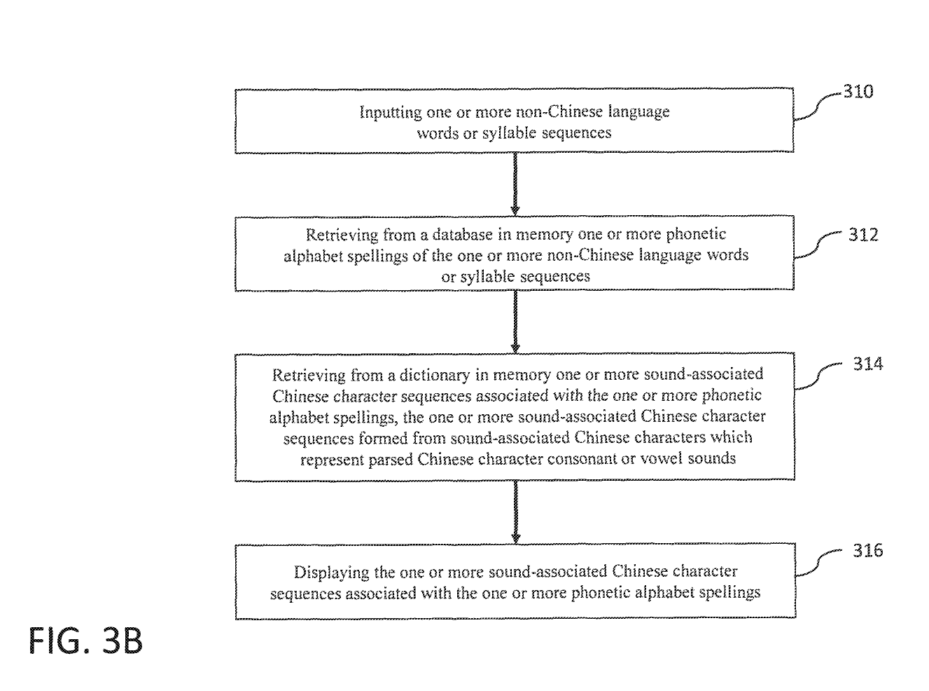

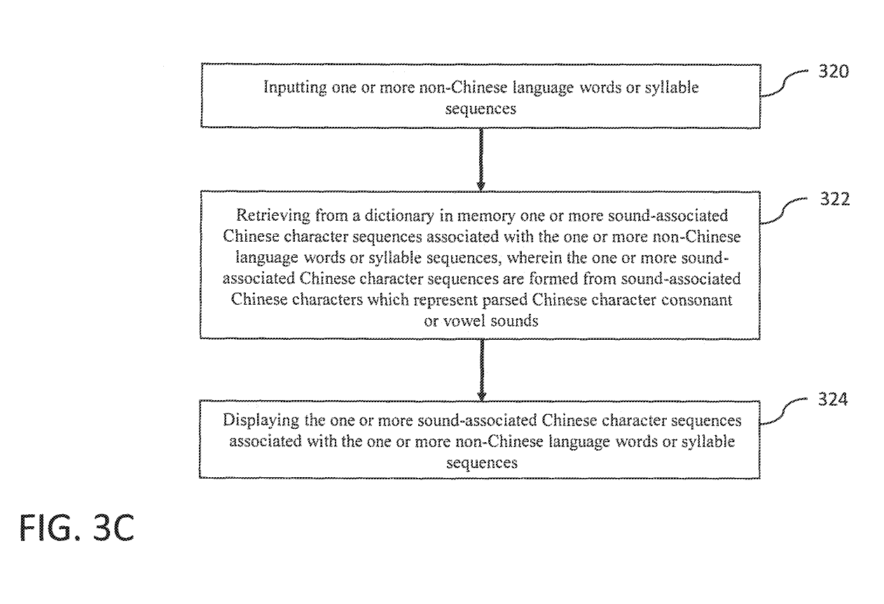

In other exemplary embodiments, the presently disclosed inventive concepts are directed to a self-contained electronic device 200 as depicted in FIG. 2 that is able to perform the methods of the presently disclosed inventive concepts (e.g., in accordance with the processes depicted in FIGS. 3A, 3B, and 3C) without the necessity of communicating with an outside network and remote memory to access a database containing the sound associated Chinese character alphabet (e.g., the SEA) or the Chinese/Non-Chinese dictionary (e.g., the SEA dictionary), although the database and operating instructions may be periodically updated with updates from an external source. Electronic device 200 contains an input module 210 for enabling input of a non-Chinese language syllable sequence (e.g., an English word) by, for example, typing on a keyboard or touch screen, by “touch capture” or “spot input” of text on a screen, or by audio-to-text conversion of voice input. The non-Chinese language syllable sequence (either directly, or before or after conversion to a phonetic alphabet spelling) is communicated to a processor device 220 which executes program instructions for either (1) converting the non-Chinese language syllable sequence into a parsed Chinese character sound sequence using, for example, a look-up table having non-Chinese language syllable sequences and their associated sound-associated Chinese characters or sound-associated Chinese character sequences that is stored in memory device/database 230, or (2) selecting from a Chinese/Non-Chinese language dictionary stored in memory device/database 230 a sound-associated Chinese character sequence which corresponds to the non-Chinese language syllable sequence, e.g., the desired English word, or a phonetic sequence (e.g. based in IPA) corresponding to the desired English word. The memory device (database) 230 can be implemented using random access memory, read only memory and combinations thereof. The sound-associated Chinese character sequence and/or the phonetic sequence corresponding to the desired English word is then stored in the memory device/(database) 230 and/or directly communicated to an output module 240 where it is expressed or displayed as a text and/or audio output for use by the user in accordance with the present disclosure. The electronic device 200 optionally includes a pronunciation aid tool 250 for aiding the user in pronouncing the Chinese character sequence obtained from or generated from the memory device/database 230. The input module 210 and output module 240 may be unitary module, for example a touch screen, which can both receive input and display output. The electronic devices 200 include, but are not limited to, electronic devices such as desktop computers, personal computers, laptop computers, computer workstations, servers, mainframe computers, handheld computer devices, personal digital assistants, pagers, camera phones and smartphones (e.g., iPhone), cellular/mobile telephones, fax machines, smart appliances, gaming consoles, digital cameras, digital vision devices (e.g., Google Glass), digital music players (e.g., iPod), tablet/notebook computers (e.g., iPad), video players, e-readers (e.g., Kindle), DVD players, Blu-ray players, televisions, copy machines, scanners, car stereos, DVRs, and home entertainment centers.

Referring to FIGS. 1, 2 and 3A, an exemplary embodiment of the method according to the present disclosure is provided. Initially, at step 300, a user (e.g., a learner or Chinese speaker) enters or inputs one or more non-Chinese words or syllable sequences into the electronic system or device using the electronic device 100 (seen in FIG. 1) or the input module 210 (seen in FIG. 2). In step 302, the entered one or more non-Chinese words or syllable sequences (e.g., one or more English words) are then converted or transcribed from the word's English spelling to a phonetic alphabet spelling (e.g., an IPA or Romanized phonetic spelling) based on phonetic alphabet symbols stored in a database. In step 304, the vowels and consonants in the phonetic alphabet spelling of the one or more non-Chinese language words or syllable sequences entered into the electronic system or device are then associated with one or more sound-associated Chinese characters or sound-associated Chinese character sequences stored, as for example a look-up table, in a database, such as memory device/database 230, wherein the sound-associated Chinese characters represent parsed Chinese character consonants and vowel sounds, thereby forming one or more sound-associated Chinese character sequences corresponding to the one or more non-Chinese words or syllable sequences. It should be noted, that the term “lookup table” as used herein can refer to a single lookup table, as well as multiple lookup tables (e.g., Tables 1 and 2) that are linked together by way of a predetermined association. The system receives the inputted non-Chinese language words or syllable sequences via the key board or print- or voice-activated system for example. The system may automatically convert each of the serial groups of non-Chinese language words or syllable sequences words or syllable sequences into a destination passage in the corresponding sound-associated Chinese characters or sound-associated Chinese character sequences established in accordance with the look-up table. In step 306, the electronic system or device then displays the one or more sound-associated Chinese character sequences associated with the non-Chinese language words or syllable sequences derived from the look-up table via the output module 240. For example, a video display device can provide, in one embodiment, a visual display of the one or more sound-associated Chinese character sequences and associated non-Chinese language words or syllable sequences for use by the user.

Referring to FIGS. 1, 2 and 3B, an exemplary embodiment of the method according to the present disclosure is provided. Initially, at step 310, a user (e.g., a learner or Chinese speaker) enters or inputs one or more non-Chinese words or syllable sequences into the electronic system or device using the electronic device 100 (seen in FIG. 1) or the input module 210 (seen in FIG. 2). In step 312, one or more phonetic alphabet spellings of the entered one or more non-Chinese words or syllable sequences (e.g., one or more English words) is retrieved from a database in a memory, such as memory device/database 230. In step 314, one or more sound-associated Chinese character sequences associated with the one or more phonetic alphabet spellings is retrieved from a database, such as memory device/database 230, wherein the sound-associated Chinese characters of the sound-associated Chinese character sequences represent parsed Chinese character consonants and vowel sounds. The system receives the inputted non-Chinese language words or syllable sequences via the key board or print- or voice-activated system for example. In step 316, the electronic system or device then displays the retrieved one or more sound-associated Chinese character sequences associated with the non-Chinese language words or syllable sequences (via the phonetic alphabet spellings). For example, a video display device can provide, in one embodiment, a visual display of the one or more sound-associated Chinese character sequences and associated non-Chinese language words or syllable sequences for use by the user.

Referring to FIGS. 1, 2 and 3C, another exemplary embodiment of the method according to the present disclosure is provided. Initially, at step 320, a user (e,g., a learner or Chinese speaker) enters or inputs one or more non-Chinese words or syllable sequences into the electronic system or device using the electronic device 100 (seen in FIG. 1) or the input module 210 (seen in FIG. 2). In step 322, the electronic system or device processes the entered one or more non-Chinese words or syllable sequences (e.g., one or more English words) and searches the Chinese/non-Chinese language dictionary stored in remote memory 120 (seen in FIG. 1) or memory device/database 230 (seen in FIG. 2) for one or more sound-associated Chinese characters or sound-associated Chinese character sequences corresponding to the one or more non-Chinese words or syllable sequences, wherein the sound-associated Chinese characters or sound-associated Chinese character sequences are formed from Chinese characters which represent parsed Chinese character consonant vowels or sounds. In step 324, the electronic system or device then displays the retrieved sound-associated Chinese characters or sound-associated Chinese character sequences associated with the one or more non-Chinese language words or syllable sequences. For example, a video display device can provide, in one embodiment, a visual display of the sound-associated Chinese characters or sound-associated Chinese character sequences and associated non-Chinese language words or syllable sequences use by the user. As another example, an audio device can broadcast pronunciation of the sound-associated Chinese characters or sound-associated Chinese character sequences,

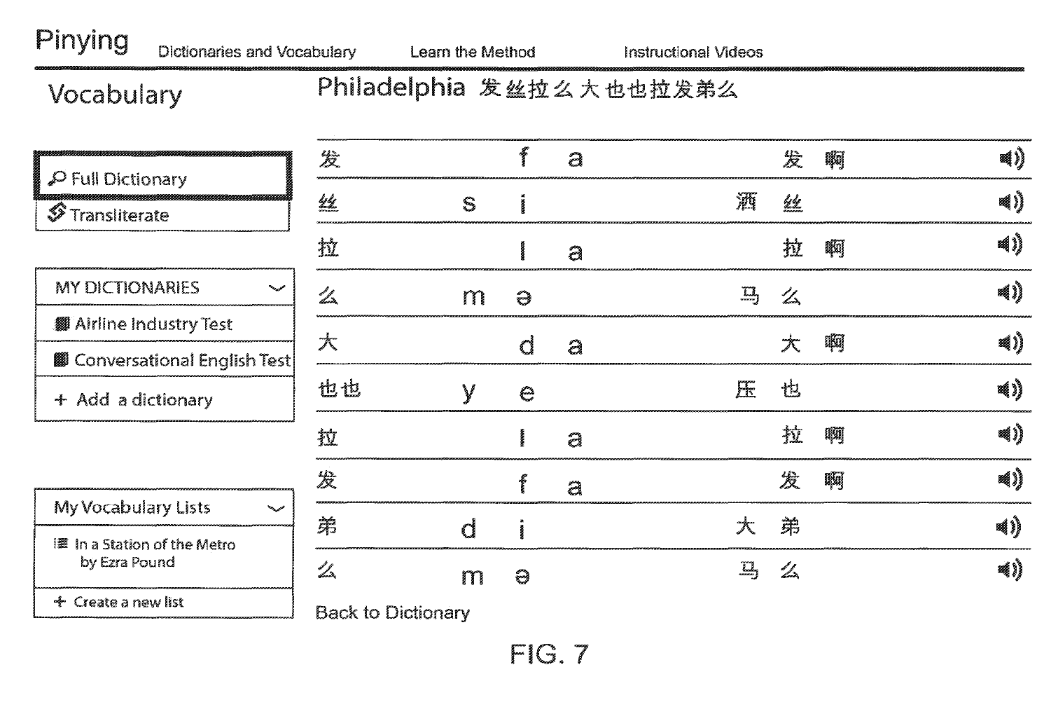

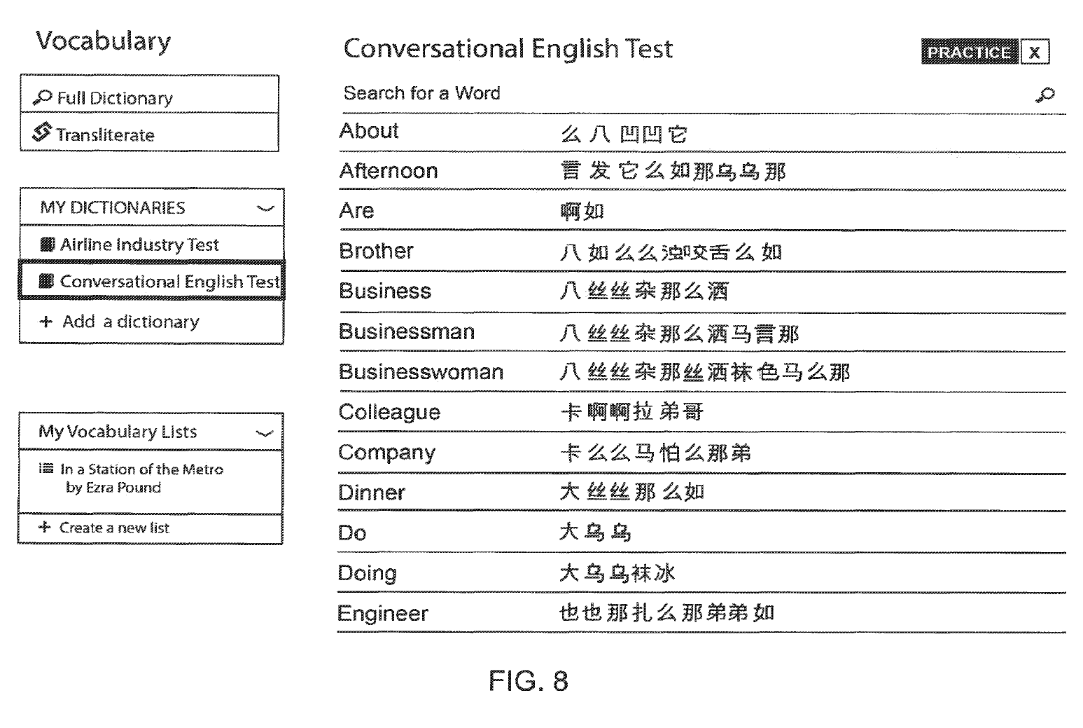

As noted, the dictionary can be stored in memory, e.g., remote memory/database 120 (seen in FIG. 1) or memory device/database 230 (seen in FIG. 2). When a particular English word is selected and input, the inputted word and the corresponding pre-constructed sound-associated Chinese character sequence (e.g., derived from the SEA) can be displayed or presented to the user on a digital screen, such as one described herein. Additionally, a selection of other words based on the inputted English word optionally may be displayed, for example as shown in FIGS. 6-8. In FIG. 6, which is a screen shot of the output from the pronunciation aid system or device based on the user inputting the letters “p h i l.” Along with the letter ‘p h i l” and its associated sound-associated Chinese character sequence (e.g., from the SEA), a selection of other words including the letters “p-h-i-l” can be presented to the user, such as “Philadelphia” can be displayed, along with each of the associated sound-associated Chinese character sequences for such words. Further, selection of one of the displayed words causes the display of the phonetic sounds associated with each sound-associated Chinese character in the sound-associated Chinese character sequence (e.g., as obtained from the SEA), corresponding to the sounds displayed on a “block” of the pronunciation aid described elsewhere herein. For example, when “Philadelphia” is selected from the screen which originated from the inputting of the letters “p h i l,” the Chinese sounds and corresponding English phonetic sounds are displayed (FIG. 7). When the user selects (or “clicks on”) one of the characters in the Chinese character sequence, and/or selects (or “clicks on”) one of the “sound” characters or symbols, an audible sound of the correct pronunciation which associated with the Chinese character may be emitted. The user can thus learn how each of the characters in the Chinese character sequence is supposed to be pronounced according to correct English usage, thus learning the standard pronunciation of the selected English word. From a list of options in the system, the user may select a set of English words and their corresponding Chinese character sequences. FIG. 8 depicts a screen shot of a conversational English test function according to the pronunciation aid system of the present disclosure, where English words and corresponding sound-associated Chinese character sequences are presented to a user.

### Pronunciation Aid Tool and Kit

In an alternate non-limiting embodiment, the presently disclosed inventive concepts are directed to a pronunciation aid tool that includes identifiers, such as “blocks” that may be in digital or non-digital form, and that may also be referred to herein as “Sinophonic English Alphabet Blocks” (SEAB), which is used to implement use of the SEA. As noted previously, the presently disclosed inventive concepts are not limited to using the SEA described herein (Tables 1 and 2). Other embodiments of the sound-associated Chinese character alphabet may also be constructed using alternate phonetic alphabets and/or alternate standard and/or contrived sound-associated Chinese characters which comprise similar consonant and vowel sounds. As noted above, the SEA enabled herein is a novel alphabet that can be used to transcribe English words into sequences of Chinese characters which serve as “letters” representing either their initial (consonant) or final (vowel) sounds. For example, as noted above, [symbol] is the Chinese character used in the SEA to represent the English /b/ sound. In Chinese pronunciation, the character [symbol] has a /ba/ sound, which is made up of two sounds: /b/ is its initial consonant sound, and /a/ is its terminal vowel sound. The SEA user learns that the character [symbol] represents the /b/ (consonant) sound value by being taught this, either with the help of a teacher to demonstrate the pronunciation aid, or alone by using instructions provided with the pronunciation aid, in a non-digital or digital embodiment. Thus, when the user sees a [symbol] in the sound-associated Chinese character sequence of a word the user is trying to pronounce, the user knows that the sound he should pronounce is the “parsed” or “cut” /b/ consonant sound, not the complete /b/ consonant/vowel sound he may normally associate with the character [symbol] . In this way the user learns to more correctly pronounce the English word without using extra, extraneous, sound values inherent in the standard pronunciation of the Chinese character.

Each sound-associated Chinese character used in, for example, the SEA is “cut” or “popped” in this way until every English phoneme is represented by a specific corresponding sound-associated Chinese character. Before users can become adept at using SEA, therefore, they must learn to “cut” or “pop” the sound-associated Chinese character sound into halves and select the correct half which is then used in a sound-associated Chinese character sequence of phonemes to accurately transcribe an English speech sound or word. The pronunciation aid tool described herein accomplishes this by creating a spatially intuitive interface to conceptualize Chinese characters as separable “blocks”, each containing multiple phonemes rather than a single morpheme. Every standard Chinese character has one syllable comprising at least an onset and final sound (but these sounds are rarely if ever broken into their separate parts). Because in certain embodiments most of the blocks in the kit of the present disclosure have multiple sides and can be split into at least two components to include multiple parts, they make segmenting sounds more intuitive and easy to understand. The pronunciation aid tool (e.g., the block) exchanges the abstract “phoneme” with a manipulative object (non-digital or digital) that allow users to physically “pop” or “cut” the morphemes (syllables) into their constituent parts and set aside the disruptive (unneeded) sounds while keeping and properly sequencing the correct sounds. This is done either by using blocks or via digital identifiers, e,g., icons, through video, digital, and other animated embodiments.

Basic Pronunciation Aid Tool Construction

In at least one embodiment, due to the fact that the sounds of English are found in different Chinese phonological environments (different characters with a variety of phonemic elements), the individual pronunciation aid tools (e.g., blocks) generally come in one of three cubic or rectangular configurations: 1. A block separable into two parts (example: b/a= [symbol] ); 2. A separable into three parts (example: y/a/n= [symbol] ), and 3. Single unitary blocks for SEA Chinese characters which do not have corresponding standard or natural Chinese sounds (i.e. characters created specifically for the SEA (for example: /th/= [symbol] ). The blocks may be stacked vertically (which is more intuitive for Chinese users) or horizontally, or even diagonally, or other suitable configuration. Examples of shapes the blocks may have include, but are not limited to, cube, square cuboid, and rectangular cuboid. Further, as noted above, the sound-associated Chinese characters which correspond to specific consonant and vowel sounds can be differentiated through font, color, underlining or any other visual stimuli or means to distinguish between characters indicating vowels rather than consonants or consonants rather than vowels.

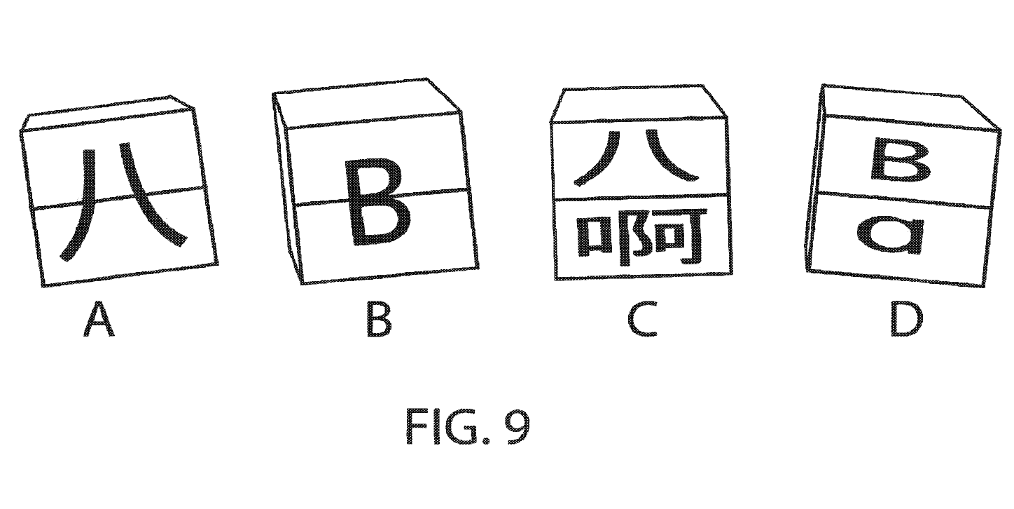

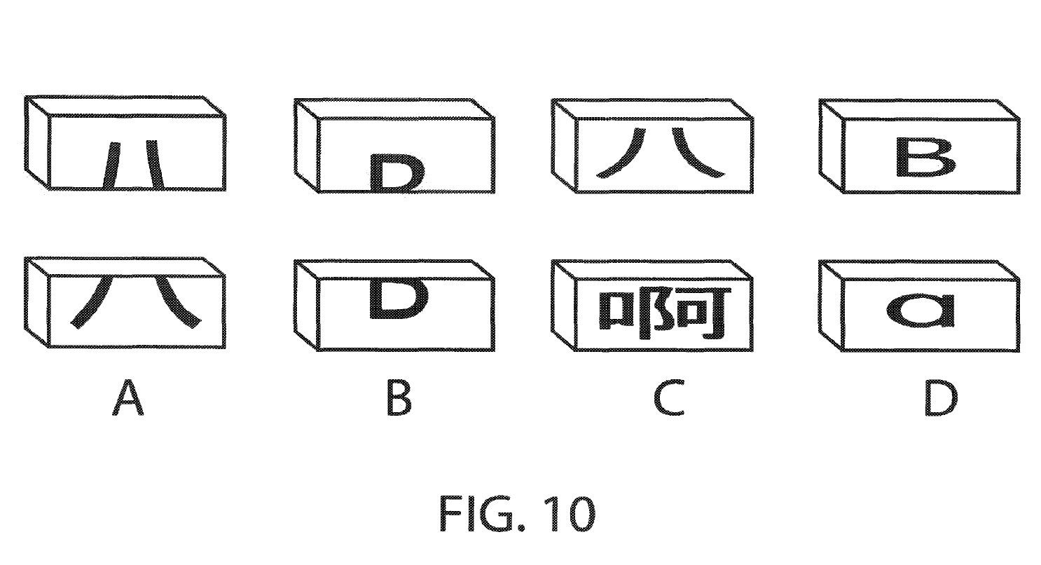

In one embodiment (FIGS. 9 and 10), the block has four side faces (not including a top surface and a bottom surface) and each of the four side faces of the block contains information, for example:
1. A first side of the block, side A, has the SEA Chinese character only, e.g., [symbol] (FIGS. 9A, 10A). This character is taken from the Chinese language and where pronounced, has a sound made up of a consonant and a vowel.
2. A second side of the block, side B, has a phonetic symbol of an English sound which is assigned to correspond to the SEA Chinese character on the first side, side A. In the case of [symbol] , the corresponding English phonetic symbol is B (FIGS. 9B, 10B).
3. A third side of the block, side C, has the SEA Chinese characters which correspond with the consonant (e.g., the upper portion of the block) and vowel (e.g., the lower portion of the block) sounds of the SEA Chinese character on the first side, side A. In the case of [symbol] , the consonant sound is [symbol] and the vowel sound is [symbol] (FIGS. 9C, 10C).
4. A fourth side of the block, side D, has the English phonetic consonant and vowel sounds which correspond to the SEA Chinese character consonant and vowel sounds shown on the third side. For the consonant sound [symbol] , the phonetic (IPA) symbol is /b/, and for the vowel sound [symbol] , the phonetic (IPA) symbol /a/ (FIGS. 9D, 10D).

The order of the symbols, characters, and/or letters on the four sides of the blocks are not limited to the above sequence and can be positioned in any sequence. For example, the English letter can be on a face adjacent the SEA Chinese character, or opposite the SEA Chinese character. In an alternate embodiment the blocks may comprise only two “printed sides,” i.e., the “third side” as described above with the two separable sound-associated Chinese characters and the “fourth side” with the two English or phonetic characters corresponding to the two sound-associated Chinese characters on the “third side.” In this embodiment, the faces which have just one character thereon are unnecessary. In an alternate embodiment the blocks may comprise only three “printed sides,” i.e., either the “first side” or “second side” as described above, the “third side” as described above with the two separable sound-associated Chinese characters and the “fourth side” with the two English or phonetic characters corresponding to the two sound-associated Chinese characters on the “third side.”

When the block is separated into two parts (“cut” or “popped”), the Chinese consonant sound (the consonant-associated Chinese character) and the phonetic symbol for the consonant sound are on two faces of one part of the block, such as the upper portion, (see upper FIG. 10C and 10D) and the Chinese vowel sound (the vowel-associated Chinese character) and the phonetic symbol for the vowel sound are on two faces of the other part of the block, such as the lower portion (see lower FIG. 10C and 10D). The user can then set aside or ignore the lower part of the block with the vowel sound, and can use the upper part of the block to provide the [symbol] consonant sound in the construction of a sound-associated Chinese character sequence for an English syllable sequence, or for any other purpose desired by the user. This process can be conducted manually using blocks, or by digital manipulation of block images or icons on a digital screen using the electronic systems or devices describe above. In certain embodiments the separation of the blocks into consonant and vowel components is accompanied by an audio version of the sound represented by the character or symbol on the block. The blocks can then be combined, as described above, into various sequences to represent English words and sounds. The manual (physical) blocks can be equipped with audio chips of other means for emitting a sound which corresponds to the sound represented by the block, when the block is physically separated into portions, and/or the audio component may be actuated by other means such as a push button built into the block.

With a full set of blocks in the pronunciation aid tools and kits, i.e., a set in which all consonant and vowel sounds are represented, a user can learn to “pop” the sounds by pulling each block apart to reveal at least two sounds (onset and rhyme) usually corresponding to a single consonant and vowel (vowels can be mono or diphthonic in nature). Once the full block has been separated (split/popped/cut), the user can discard (set aside) the sound that is not needed (often the disruptive sound or sounds that creates linguistic interference and negative transference from L1 to L2), and places the selected portion of the block into alignment with other portions of blocks representing selected phonetic sounds to create English phonemic sequences (syllables, words and phrases), e.g., the proper phonemic sequence for, in this exemplary embodiment, Standard American English speech sounds.

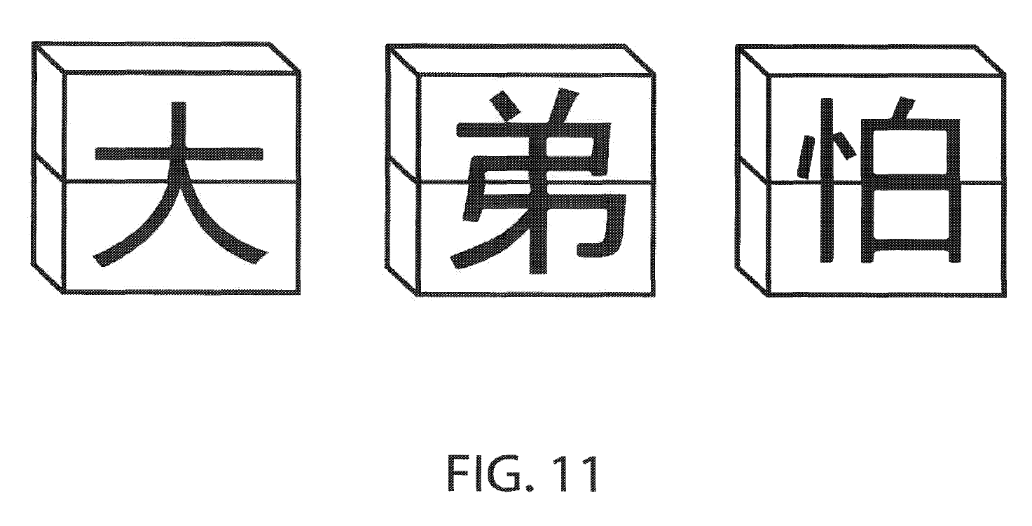

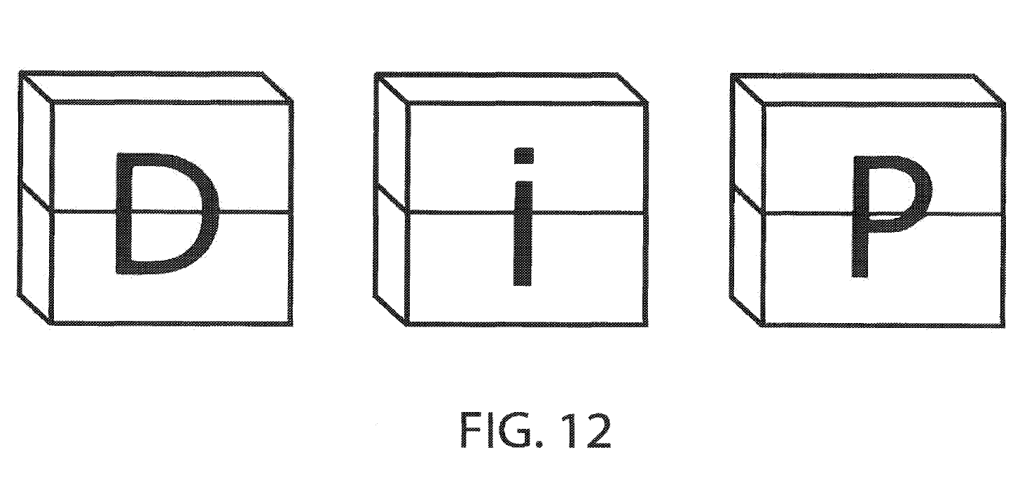

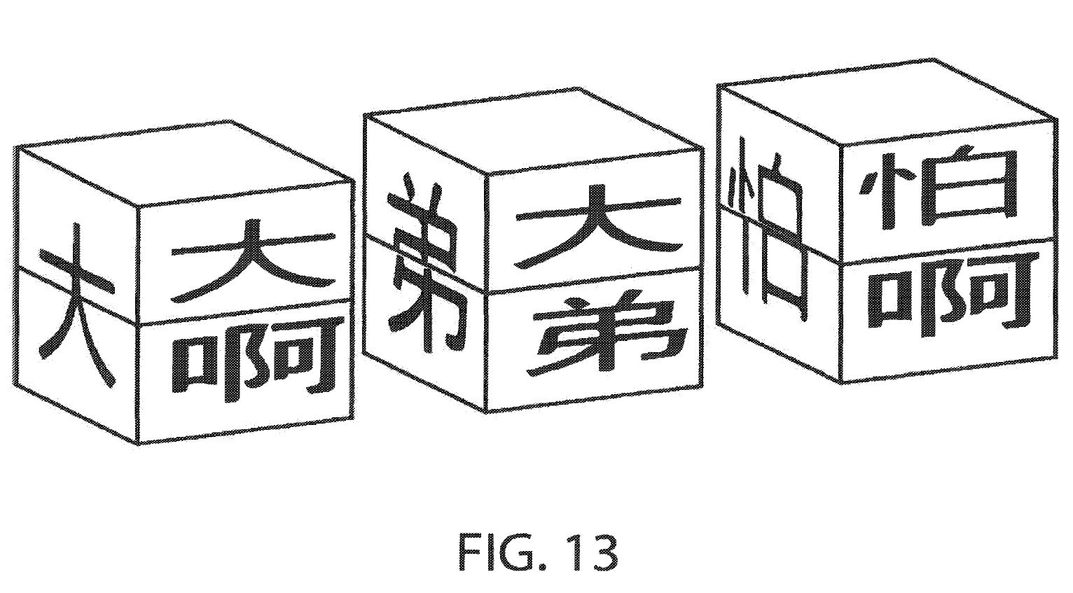

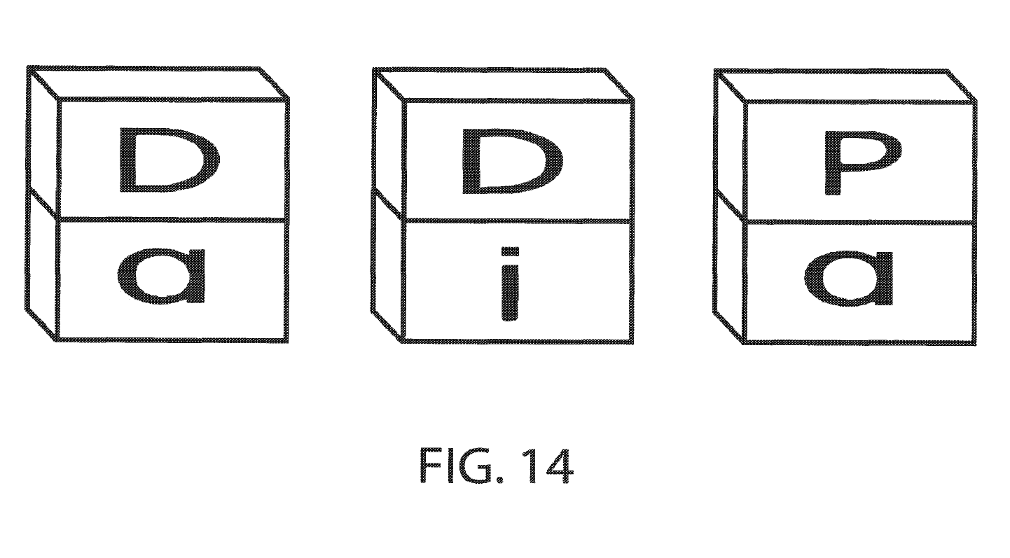

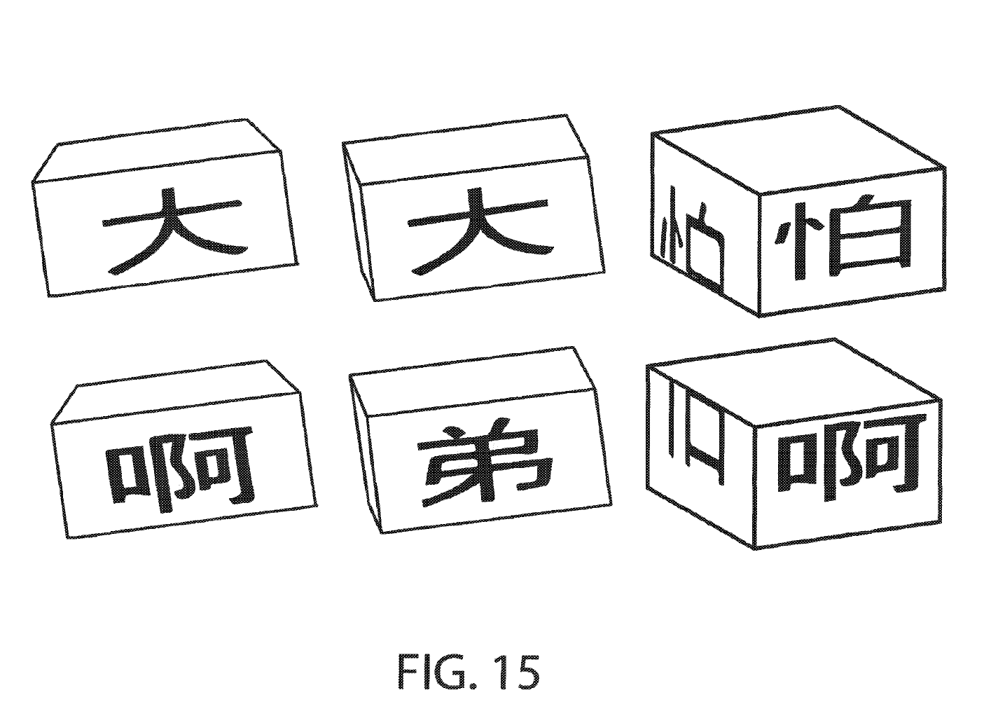

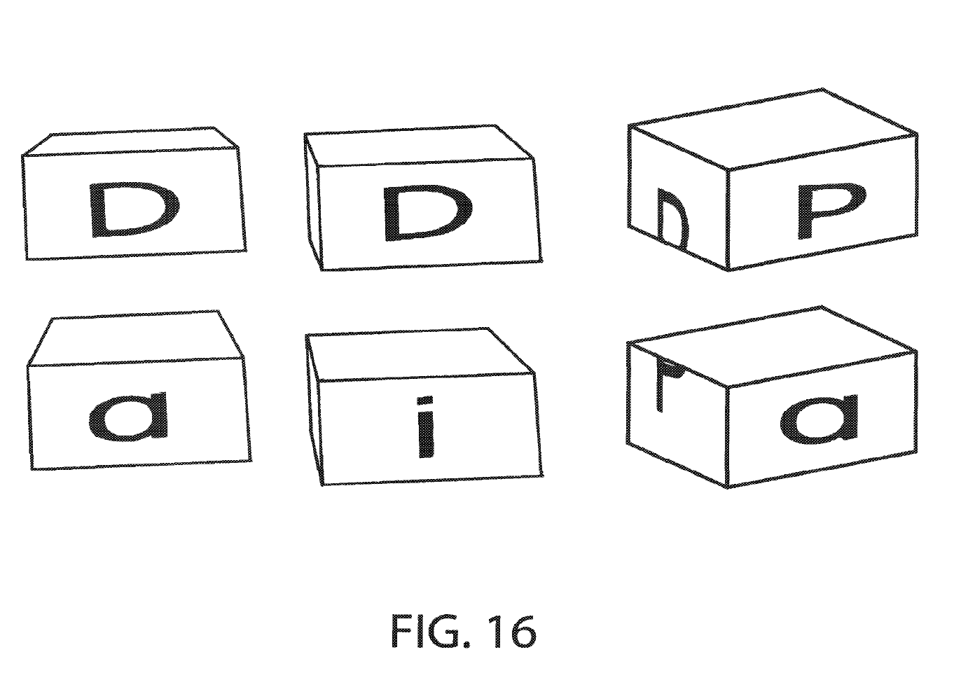

A particular, non-limiting, example of a method of using the block tool to transcribe an English word into a sound-associated Chinese character sequence in accordance with the presently disclosed inventive concepts is the transcription of the English word “deep”. The word /deep/ in SEA is transcribed as: [symbol] . The transcription of the word /deep/ requires three blocks. The first sides of the three blocks have the large single characters [symbol] , [symbol] , and [symbol] covering the whole block face (FIG. 11). The second sides of the three blocks have English letters which are assigned to uniquely correspond to the sound-associated Chinese character on the first sides, and in this case are D, i, and P (FIG. 12). The third sides (upper portions and lower portions, respectively) of the blocks have the sound-associated Chinese characters which correspond with the consonant ( [symbol] , [symbol] , and [symbol] ), and vowel sounds ( [symbol] , [symbol] , and [symbol] ) of the sound-associated Chinese character on the first sides (FIG. 13). The fourth sides (upper portions and lower portions, respectively) of the blocks have the IPA symbols D, D, and P, which correspond with the SEA Chinese consonant sounds [symbol] , [symbol] , and [symbol] on the third sides, and the IPA symbols a, i, a which correspond to the SEA Chinese vowel sounds [symbol] , [symbol] , and [symbol] of the SEA Chinese character on the third sides (FIG. 14). As noted above, the order of the symbols, characters, and/or letters on the four sides of the blocks are not limited to the above sequence and can be positioned in any sequence. For example, the English letters can be on a face adjacent the sound-associated Chinese character, or opposite the sound-associated Chinese character, and the IPA consonant and vowel characters can be on faces adjacent the sound-associated Chinese character, or opposite the sound-associated Chinese characters. In accordance with the disclosure provided above, the “consonant” portion of the block can be separated (“popped”) from the “vowel” portion of the block (FIGS. 15 and 16). Further, as noted above, sound-associated Chinese character consonants and vowels can be differentiated through font, color, underlining or any other visual stimuli or means to distinguish between characters indicating vowels rather than consonants or consonants rather than vowels.

The “cut/popped” block portions (FIGS. 15 and 16) are now ready to be positioned in a sequence which corresponds to a sound-associated Chinese character sequence which represents the English syllable sequence. The blocks may be, for example, affixed to a horizontal platform or a vertical platform. The block portions may be affixed by interlocking mechanisms that allow the blocks to be affixed and un-affixed cover the top and bottom faces of the cubes or side faces to allow each of the cut blocks to be affixed sequentially on a horizontal plane using a platform block. Alternatively, the popped/cut blocks can be arranged vertically. Blocks can also be affixed in formats akin to Korean graphemic principles. The physical embodiment of the blocks can be affixed, for example, by affixing devices, such as hook and loop fabrics, textures, magnets, snaps, links, tabs, bands, tacky adhesives or other attachable/detachable mechanisms known to persons having ordinary skill in the art.

Digital embodiments using the electronic systems and devices described above of the block tools operate by the same basic principles as their physical counterparts except that as digital 3D images and animations, they do not need physical affixers. Digital embodiments could include immersive learning environments including 3D virtual reality (e.g. Oculus), augmented reality (e.g. Hololens), or augmented virtuality interfaces as well as touchscreen devices or Projection augmented devices etc.

In one embodiment, the presently disclosed inventive concepts are directed to systems and methods of using a pronunciation aid for aiding “English as a Foreign Language” instruction using a series of identifiers which reveal Chinese characters and their normal Mandarin sound values such as those associated with the Sinophonic English Alphabet, as described above. The pronunciation aid may include a set of identifiers (e.g., blocks) or digital versions thereof. In one embodiment, the pronunciation aid includes 41 SEA Chinese characters on blocks which can he turned to each of the several sides to instruct students which sounds associated with the normal Mandarin pronunciation of each character are to be “cut out” and which sound or sounds are to be kept in order to sequence the phonemes correctly into standard English pronunciations. The following is another example of how the pronunciation of “cut” sounds is used to teach the standard (correct) pronunciation of an English word using the SEA. In this example, transcription the English word “set” is demonstrated.
1. A teacher selects blocks with the front facing sound-associated Chinese characters / [symbol] / / [symbol] / and / [symbol] / which represent the English word /set/.
2. Using the blocks of the pronunciation aid, a teacher would select these blocks from within a collection of all 41 blocks grouped into consonants and vowels, having the student turn each block so that the face /s/ or / [symbol] /, /e/ or [symbol] / and /t/ or / [symbol] / is facing him. It should be noted that the collection of blocks can be in the form of a kit of blocks or the collection of blocks can be stored in a digital look-up table or dictionary as described herein.
3. The teacher pronounces (e.g., in a classroom setting or via a video) the correct “cut” sound associated with this character and letter.
4. The blocks are turned so that the students (or users) are facing the sides with two phonetic symbols (one upper and one lower). The teacher explains that consonant sounds are usually upper and vowel sounds are usually lower. When a sound-associated Chinese character represents a consonant, students learn to “cut out” the vowel (lower sound), and when a sound-associated Chinese character represents a vowel, students learn to “cut out” the consonant (upper sound).
5. To aid in this concept, blocks may be turned to the side having the two sound-associated Chinese characters which represent the consonant sound (upper character) and the vowel sound (lower character).
6. Teachers will then demonstrate or ask students to “pop” (separate) the block and either discard the portion with the extraneous sound (unused consonant or vowel), or reconnect them but turn them to the front again to emphasize the correct sound-character match.
7. Students practice saying the correct sounds out loud paying extra attention to ensure the extraneous sounds are not articulated.

8. The front facing single sound-associated Chinese character (if present) corresponds to the correct character on the side showing two sound-associated Chinese characters. Alternatively the correct character may be indicated by a difference in font, color, or other indicator.
9. After teachers have taught how to cut each sound from the block and isolate the proper sound in each sound-associated Chinese character, and when students are able to articulate the correct sounds individually, students begin to read these correct sounds in the specific sequence of blocks /s/ /e/ /t/. This step is repeated until the student is comfortable with the English pronunciation.
10. The same procedure is followed for the characters making up the words “sit” and “seat”.
11. The teacher can focus student attention on the different vowel sounds in the corresponding sound-associated Chinese, e.g., Sinophonic English Alphabet characters: / [symbol] , / [symbol] /, and / [symbol] /. While students may often ignore the different sounds associated with the English counterparts, teachers can focus students on hearing these differences in the Chinese then applying these differences to distinguish between the English equivalents.
12. After the vowel blocks have been used to localize these different sounds, students can place them into their proper English sequences again.
13. This process can take many forms, but in any case teachers use the blocks (non-digital or digital) to help the Chinese English learner improve his phonological awareness, memorize the sound-associated Chinese character alphabet, e.g., the SEA, to allow him the ability to look up any English word, and get the sound-associated Chinese character sequence, e.g., the SEA character sequence, equivalent so that he can improve his pronunciation and listening comprehension skills through an assortment of related exercise, drills, and games using this pronunciation aid.

Another embodiment of the presently disclosed inventive concepts is directed to a pronunciation aid system and method of use, wherein the pronunciation aid system includes a dictionary stored in the system memory, and/or access to such, containing non-Chinese (e.g., English) words and corresponding sound-associated Chinese character sequences pre-constructed from the sound-associated Chinese character alphabet (as explained elsewhere herein). When a particular non-Chinese word is selected and input, the inputted word and the corresponding pre-constructed sound-associated Chinese character sequence is displayed or presented to the user on a digital screen, such as one described elsewhere herein. Additionally, a selection of other words based on the inputted non-Chinese word optionally may be displayed, for example as shown in FIGS. 6-8. In FIG. 6, which is a screen shot of the output from the pronunciation aid system based on the user inputting the letters of the English word “p h i l.” Along with the letter ‘p h i l” and its associated sound-associated Chinese character sequence, a selection of other words including the letters “p-h-i-l” are presented to the user, such as “Philadelphia” is displayed, along with each of the associated sound-associated Chinese character sequences. Further, selection of one of the displayed words causes the display of the phonetic sounds associated with each sound-associated Chinese character in the sound-associated Chinese character sequence, corresponding to the sounds displayed on a “block” of the pronunciation aid described elsewhere herein. For example, when “Philadelphia” is selected from the screen which originated from the inputting of the letters “p h i l,” the Chinese sounds and corresponding English phonetic sounds are displayed (FIG. 6). When the user selects (or “clicks on”) one of the characters in the Chinese character sequence, and/or selects (or “clicks on”) one of the “sound” characters or symbols, an audible sound of the correct pronunciation which associated with the Chinese character may be emitted. The user can thus learn how each of the characters in the Chinese character sequence is supposed to be pronounced, thus learning the standard pronunciation of the selected non-Chinese word. From a list of options in the system, the user may select a set of non-Chinese (e.g., English) words and their corresponding sound-associated Chinese character syllable sequences. FIG. 8 depicts a screen shot of a conversational English test function according to the pronunciation aid system of the present disclosure, where English words and corresponding sound-associated Chinese character sequences are presented to a user.

While the presently disclosed inventive concepts have been described herein in connection with certain embodiments so that aspects thereof may be more fully understood and appreciated, it is not intended that the presently disclosed inventive concepts be limited to these particular embodiments. On the contrary, it is intended that all alternatives, modifications and equivalents are included within the scope of the presently disclosed inventive concepts as defined herein. Thus the examples described above, which include particular embodiments, will serve to illustrate the practice of the presently disclosed inventive concepts, it being understood that the particulars shown are by way of example and for purposes of illustrative discussion of particular embodiments of the presently disclosed inventive concepts only and are presented in the cause of providing what is believed to be the most useful and readily understood description of procedures as well as of the principles and conceptual aspects of the inventive concepts. Changes may be made in the construction of the apparatus and methods described herein or in the steps or the sequence of steps of the methods described herein without departing from the spirit and scope of the presently disclosed inventive concepts. Further, while various embodiments of the presently disclosed inventive concepts have been described in claims herein below, it is not intended that the presently disclosed inventive concepts be limited to these particular claims. Applicants reserve the right to amend, add to, or replace the claims indicated herein below in subsequent patent applications.

The following are considered to be exemplary and not exhaustive of embodiments of the inventive concepts of the present disclosure which may be claimed and are not intended to be limiting of the embodiments which may be claimed in a subsequent application.

What is claimed is:

1. A pronunciation aid system, comprising:
a memory having a database stored therein, the database comprising a plurality of non-Chinese language words or syllable sequences and a plurality of sound-associated Chinese character sequences which correspond to the non-Chinese language words or syllable sequences, wherein the plurality of sound-associated Chinese character sequences are formed from consonant-associated Chinese characters which represent parsed Chinese character consonant sounds and vowel-associated Chinese characters which represent parsed Chinese character vowel sounds;
a data entry device for inputting one or more selected non-Chinese language words or syllable sequences;
a display device for displaying the inputted one or more selected non-Chinese language words or syllable sequences and the sound-associated Chinese character sequences which correspond thereto; and
an auditory device for producing audible sounds which represent pronunciations of the consonant-associated Chinese characters and vowel-associated Chinese characters used to form the sound-associated Chinese character sequences.

2. The pronunciation aid system of claim 1, wherein the display device is for displaying symbols representing the consonant-associated Chinese characters and vowel-associated Chinese characters used to form the sound-associated Chinese character sequences.

3. The pronunciation aid system of claim 1, wherein the database further comprises phonetic alphabet spellings of the non-Chinese language words or syllable sequences.

4. The pronunciation aid system of claim 1, wherein the non-Chinese language is English.

5. The pronunciation aid system of claim 1, wherein the memory further comprises stored instructions which when executed by a computer cause the computer to:
store, in the database, the one or more selected non-Chinese language words or syllable sequences, wherein the one or more selected non-Chinese language words or syllable sequences are selected using the data entry device;
display, on the display device, the one or more selected non-Chinese language words or syllable sequences and the sound-associated Chinese character sequences which correspond thereto; and
produce, using the auditory device, the audible sounds which represent pronunciations of the consonant-associated Chinese characters and vowel-associated Chinese characters used to form the sound-associated Chinese character sequences.

6. A device for aiding in the pronunciation of a non-Chinese language word or syllable sequence, comprising:
a digital device comprising (1) a data entry device, (2) a display device, and (3) an auditory device, and (4) a memory having a database stored therein,
wherein the database comprises a dictionary of non-Chinese language words or syllable sequences and sound-associated Chinese character sequences which correspond to the non-Chinese language words or syllable sequences, wherein the sound-associated Chinese character sequences of the dictionary are formed from consonant-associated Chinese characters which represent parsed Chinese character consonant sounds and vowel-associated Chinese characters which represent parsed Chinese character vowel sounds, and
wherein when one or more selected non-Chinese language words or syllable sequences are inputted via the data entry device, one or more of the sound-associated Chinese character sequences in the dictionary which correspond to the one or more selected non-Chinese language words or syllable sequences are retrieved from the dictionary of the database and displayed on the display device.

7. The device of claim 6, wherein the auditory device is able to produce one or more audible sounds which represent pronunciations of the consonant-associated Chinese characters and vowel-associated Chinese characters used to form the sound-associated Chinese character sequences.

8. The device of claim 6, wherein the non-Chinese language words or syllable sequences are English.

9. A method for aiding in the pronunciation of a non-Chinese language word or syllable sequence, comprising:
using a digital device comprising (1) a data entry device, (2) a display device, and (3) an auditory device, and (4) a memory having a database stored therein, wherein the database comprises a dictionary of non-Chinese language words or syllable sequences and sound-associated Chinese character sequences which correspond to the non-Chinese language words or syllable sequences, wherein the sound-associated Chinese character sequences of the dictionary are formed from consonant-associated Chinese characters which represent parsed Chinese character consonant sounds and vowel-associated Chinese characters which represent parsed Chinese character vowel sounds; and
inputting into the digital device one or more selected non-Chinese language words or syllable sequences via the data entry device thereby causing one or more of the sound-associated Chinese character sequences in the dictionary to be retrieved from the database and displayed on the display device.

10. The method of claim 9, wherein the auditory device is caused to produce one or more audible sounds which represent pronunciations of the consonant-associated Chinese characters and vowel-associated Chinese characters used to form the sound-associated Chinese character sequences of the dictionary.

11. The method of claim 9, wherein the non-Chinese language is English.

12. A non-transitory computer readable storage medium to tangibly store instructions, which when executed by a computer cause the computer to:
convert one or more entered non-Chinese language words or syllable sequences into a corresponding phonetic alphabet spelling based on phonetic symbols stored in a database;
form one or more sound-associated Chinese character sequences by associating consonant and vowel sounds of the phonetic alphabet spelling with one or more consonant-associated Chinese characters or vowel-associated Chinese characters stored in a look-up table in a non-transitory memory, wherein the consonant-associated Chinese characters and vowel-associated Chinese characters stored in the look-up table represent parsed Chinese character consonant and vowel sounds; and
display the one or more sound-associated Chinese character sequences based on the consonant-associated Chinese characters and vowel-associated Chinese characters and the one or more non-Chinese language words or syllable sequences corresponding thereto to enable a speaker to reference the one or more sound-associated Chinese character sequences to enunciate the one or more non-Chinese language words or syllable sequences.

13. The non-transitory computer readable storage medium of claim 12, wherein the non-Chinese language is English.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A pronunciation aid method comprises stored computer instructions which when executed by a computer cause the computer to:
display, on a display device, a plurality of pronunciation aid tools, wherein each of the one or more pronunciation aid tools includes a plurality of identifiers displaying language related symbols, comprising:
a first identifier displaying a first Chinese character and at least one second Chinese character, wherein the first Chinese character and the at least one second Chinese character together represent a standard pronunciation of the first Chinese character; and
a second identifier displaying a first grapheme and at least one second grapheme which have pronunciations that correspond to the first Chinese character and the at least one second Chinese character, respectively, wherein the first grapheme and the at least one second grapheme are selected from the group consisting of phonetic alphabet graphemes and non-Chinese language letters, and wherein the first grapheme represents an intended pronunciation of the first Chinese character;
select, in response to user input from a data entry device, a subset of the plurality of pronunciation aid tools, the subset corresponding to a non-Chinese language word having a specific order of consonant sounds and vowel sounds; and
separate the subset of pronunciation aid tools into separate portions which correspond to the consonant sounds or vowel sounds of the non-Chinese language word.

52. The method of claim 51, wherein the stored instructions include additional instructions which when executed by a computer cause the computer to:
arrange the separate portions into a sequence which corresponds to specific order of the consonant sounds and vowel sounds of the non-Chinese language word.

53. The method of claim 51, wherein in the step of separating the subset of pronunciation aid tools into separate portions which correspond to the consonant sounds or vowel sounds of the non-Chinese language word, includes the generation of an audible digital sound which corresponds to the intended pronunciation of the selected Chinese character on the first face is emitted when separate portions are separated.

54. (canceled)

55. (canceled)

56. (canceled)

57. (canceled)
